(19) United States
(12) Patent Application Publication
(10) Pub. No.: US 2013/0221032 A1
(43) Pub. Date: Aug. 29, 2013

(54) Mechanical Dispensing System

(71) Applicant: The Coca-Cola Company, Atlanta, GA (US)

(72) Inventors: Joseph T. Norris, Cumming, GA (US); John Philip Kalinowsky, Danbury, CT (US); Jesse S. Kruska, New Haven, CT (US); John Kevin Clay, Milford, CT (US)

(73) Assignee: THE COCA-COLA COMPANY, Atlanta, GA (US)

(21) Appl. No.: 13/773,944

(22) Filed: Feb. 22, 2013

Related U.S. Application Data
(60) Provisional application No. 61/602,673, filed on Feb. 24, 2012.

(51) Int. Cl. B67D 7/06

(52) U.S. Cl. CPC B05B 1/326
USPC 222/185.1; 222/505; 222/484; 222/183

(57) ABSTRACT

The present application provides a dispensing system for dispensing a beverage from a container. The dispensing system may include a dispensing valve adapted to be positioned within the container, a dispensing valve receptacle for receiving the dispensing valve, and a dispensing lever connected to the dispensing valve receptacle. Moving the dispensing lever causes the dispensing valve receptacle to rotate the dispensing valve so as to dispense the beverage from the container.

### RELATED APPLICATIONS

The present application is a non-provisional application claiming priority to U.S. Provisional Application Ser. No. 61/602,673, filed on Feb. 24, 2012. U.S. Provisional Application Ser. No. 61/602,673 is incorporated herein by reference in full.

### TECHNICAL FIELD

The present application and the resultant patent relate generally to mechanical dispensing system and more particularly relate to a mechanical beverage dispensing system that dispenses premixed or otherwise ready to drink beverages in a controlled and efficient manner.

### BACKGROUND OF THE INVENTION

Generally described, modern beverage dispensers may be relatively complex electromechanical devices. A typical beverage dispenser may mix multiple ingredients to produce a beverage via a combination of pumps, valves, and other components as operated by an electronic controller and the like. Such complex electromechanical beverage dispensers, however, may not be suitable for use in all locations. For example, the size or cost of the beverage dispenser may not be practical for a given location, the location may lack reliable electric power, the location may lack portable water supplies, or the location may lack the infrastructure required to provide or store the different beverage ingredients. Other factors also may have an impact on the reliability of the beverage dispenser and/or the quality of the beverages dispensed therefrom.

There is thus a desire for an improved mechanical dispensing system that does not require complex electromechanical components to operate. Preferably, such a mechanical dispensing system may provide premixed or otherwise ready to drink beverages in a low cost and efficient manner that maintains the quality of the beverage in terms of carbonation and the like over an extended period of time.

### SUMMARY OF THE INVENTION

The present application and the resultant patent thus provide a dispensing system for dispensing a beverage from a container. The dispensing system may include a dispensing valve adapted to be positioned within the container, a dispensing valve receptacle for receiving the dispensing valve, and a dispensing lever connected to the dispensing valve receptacle. Moving the dispensing lever causes the dispensing valve receptacle to rotate the dispensing valve so as to dispense the beverage from the container.

The present application and the resultant patent further provide a method of dispensing a beverage from a container. The method may include the steps of positioning a dispensing valve within the container, positioning the dispensing valve and the container within a collar, rotating a nozzle portion of the dispensing valve so as to raise a bulb away from a sealing surface to create a fluid flow path therethrough, and providing an air flow path through one or more airfoils positioned within the nozzle.

The present application and the resultant patent further provide a dispensing system for dispensing a beverage from a container. The dispensing system may include a closure with a frangible seal adapted to be positioned on the container, a cradle for receiving the container, a dispensing valve positioned adjacent to the container, and a dispensing lever connected to the dispensing valve. Moving the dispensing lever causes the dispensing valve to break the frangible seal so as to dispenser the beverage from the container.

The present application and the resultant patent further provide a dispensing valve for dispensing a beverage from a container. The dispensing valve may include a closure sized for the container, a nozzle rotatably positioned about the closure, and a piston attached to the nozzle and extending through the closure. Rotation of the nozzle causes the piston to disengage from a sealing surface in the closure.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a perspective view of an example of a beverage dispensing system as may be described herein.

FIG. 2 is a perspective view of the beverage dispensing system of FIG. 1.

FIG. 3 is a perspective view of a cradling and dispensing system of the beverage dispensing system of FIG. 1.

FIG. 4 is a perspective view of a dispensing valve for use with the beverage dispensing system of FIG. 1.

FIG. 5 is an exploded view of the dispensing valve of FIG. 4.

FIG. 6 is a side cross-sectional exploded view of the dispensing valve of FIG. 4.

FIG. 7 is a sectional view of the dispensing valve of FIG. 4 in a closed position.

FIG. 8 is a sectional view of the dispensing valve of FIG. 4 in an opened position.

FIG. 9 is a sectional view of an alternative embodiment of a dispensing valve as may be described herein.

FIG. 10 is a sectional view of an alternative embodiment of a dispensing valve as may be described herein.

FIG. 11 is a sectional view of an alternative embodiment of a dispensing valve as may be described herein.

FIG. 12 is a perspective view of an alternative embodiment of a cradling and dispensing system as may be described herein.

FIG. 13 is a sectional view of a dispensing valve as may be used in the cradling and dispensing system of FIG. 12.

FIG. 14 is a perspective view of an alternative embodiment of a dispensing lever as may be described herein.

FIG. 15 is a perspective view of an alternative embodiment of a dispensing lever as may be described herein.

### DETAILED DESCRIPTION

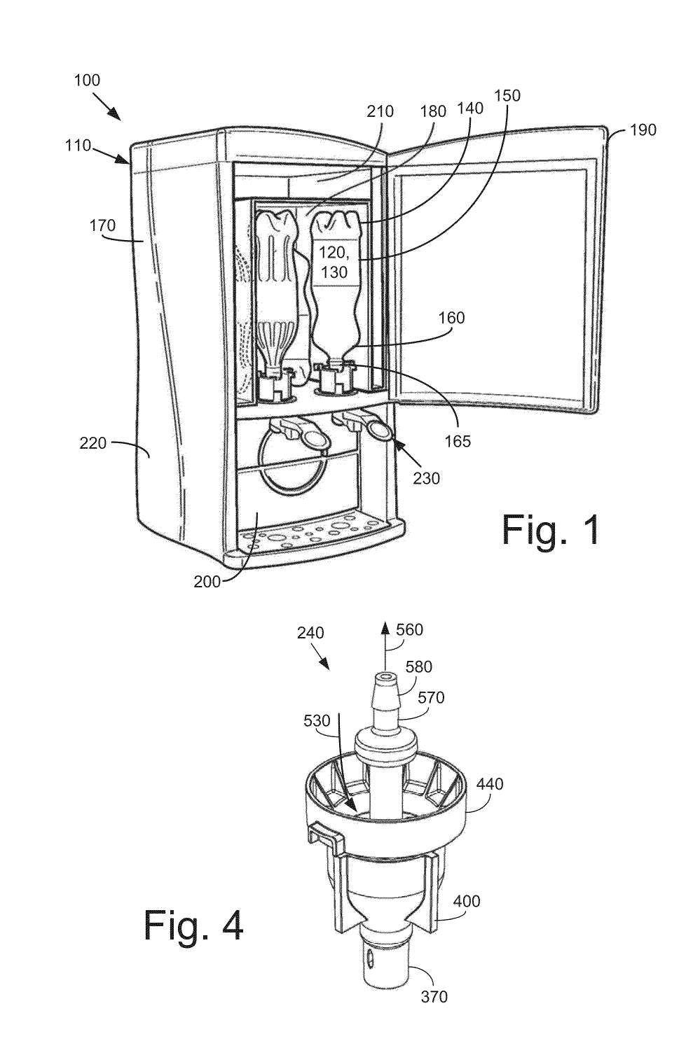

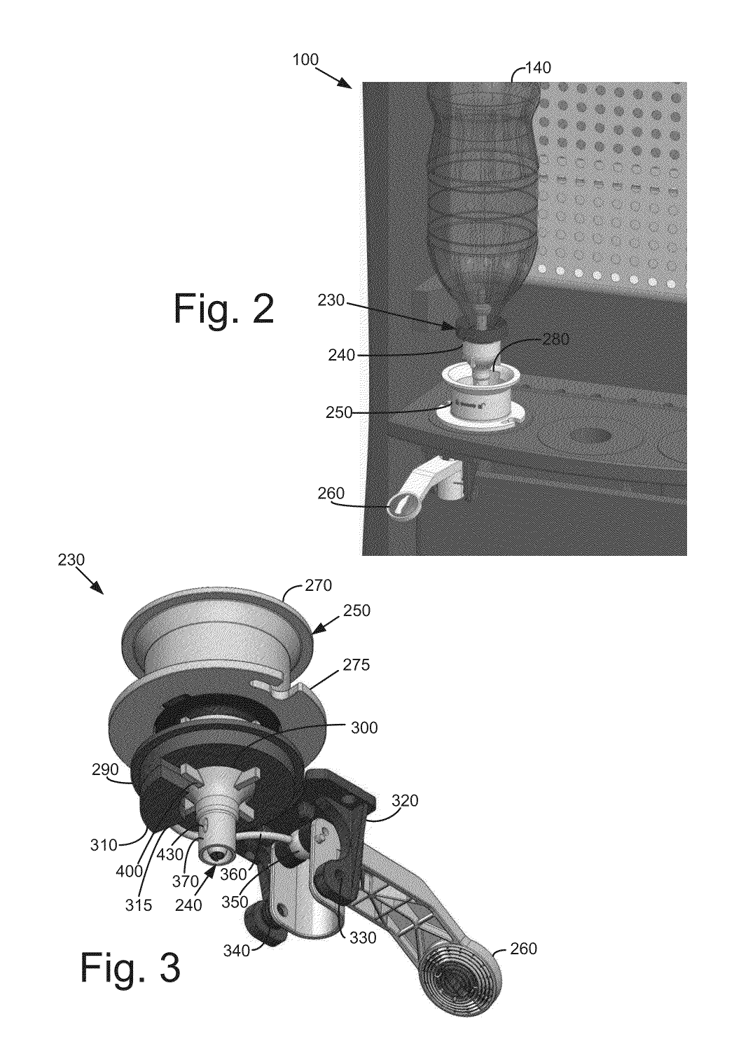

Referring now to the drawings, in which like numerals refer to like elements throughout the several views, FIGS. 1 and 2 show a dispensing system 100 as may be described herein. The dispensing system 100 may take the form of a beverage dispensing system 110. The beverage dispensing system 110 may dispense a number of beverages 120 therein. The beverages 120 may include a number of premixed or otherwise ready to drink beverages 130. The beverages 120 may include waters, juices, carbonated soft drinks, sports drinks, coffees, teas, and the like. Any type of beverages 120 may be used herein. The beverages 120 may be stored within a container 140. The container 140 may be a conventional one (1), one and a half (1.5), or two (2) liter bottle such as those commonly used for carbonated soft drinks and the like. Any type of container 140 may be used herein in any size, shape, or configuration. The container 140 may be made out of any semi-rigid material including thermoplastics, glass, metal, and the like. The container 140 may include a body 150 and a neck 160 with threads 165 thereon. Other components and other configurations may be used herein.

The dispensing system 100 may include an outer enclosure 170. The outer enclosure may be a free standing device and may have any size, shape, or configuration. The enclosure 170 may be made out of any substantially rigid materials including thermoplastics, wood, metal, and the like. The outer enclosure 170 may include a beverage section 180 enclosed by a door 190 and a lower dispensing section 200. The beverage section 180 may have any number of the containers 140 therein. The beverage section 180 also may include a thermal section 210. Ice and the like may be positioned within the thermal section 210 to exchange heat with the containers 140 in the beverage section 180. Any type of heat exchange device may be used herein. An internal storage section 220 and the like may be positioned about the lower dispensing section 200. Other sections, other components, and other configurations may be used herein. An example of the outer enclosure 170 and the sections therein is shown in commonly owned U.S. patent application Ser. No. 13/273,140, filed on Oct. 13, 2011, entitled “Beverage Dispensing Device.” U.S. patent application Ser. No. 13/273,140 is incorporated herein by reference in full.

FIG. 2 and FIG. 3 show an example of a coupling and dispensing system 230 as may be described herein for use with the dispensing system 100. Generally described, the coupling and dispensing system 230 may include a dispensing valve 240 positionable within the neck 160 of the container 140, a cradle 250 to support the container 140 in the dispensing section 200, and a dispensing lever 260 extending into the dispensing section 200 so as to allow a consumer to dispense the beverage 120 into a cup, a glass, and the like. Other components and other configurations also may be used herein.

The cradle 250 may include a raised collar 270. The collar 270 may rotate about a fixed stem 275. The collar 270 may have a number of guides 280 therein so as to mate with a conforming structure on the dispensing valve 240 as will be described in more detail below. The guides 280 may be an indent extending into the collar 270 or other type of structure. The collar 270 may be made out of any substantially rigid material such as thermoplastics and metals. The container 140 with the dispensing valve 240 thereon may be positively positioned within the cradle 250. The collar 270 then may be rotated so as to lock the container 140 in place. The container 140 may be removed in a reverse fashion.

The cradle 250 also may include a dispensing valve receptacle 290 positioned about the collar 270. The dispensing valve receptacle 290 may be positioned underneath the collar 270 and may be in communication with the dispensing lever 260 for rotation therewith. The dispensing valve receptacle 290 may be sized to accept the dispensing valve 240 therein. Specifically, the dispensing valve receptacle 290 may include a central aperture 300 for a portion of the dispensing valve 240 to extend therethrough. The dispensing valve receptacle 290 also may have one or more keys 310 positioned about the central aperture 300. The keys 310 may be sized for engagement with a corresponding structure on the dispensing valve 240 as will be described in more detail below. The dispensing valve receptacle 290 may be made out of any substantially rigid material such as thermoplastics and metals. Other components and other configurations may be used herein.

The dispensing lever 260 may be mounted within a frame 320 for rotation therewith about a pivot point 330. The dispensing lever 260 may have any size, shape, or configuration. The dispensing lever 260 may be mounted within the frame 320 with one or more springs 340 so as to provide return motion after the dispensing lever 260 has been released. The springs 340 may be torsion springs, leaf springs, and the like. The dispensing lever 260 may be made out of any substantially rigid material such as thermoplastics and metals.

The dispensing lever 260 may be in communication with the dispensing valve receptacle 290 via a ball joint 350 and a ball joint rod 360. The ball joint rod 360 may be in communication with a ball socket 315 formed in one or more of the keys 310 of the dispensing valve receptacle 290. As such, depressing the dispensing valve 260 causes the ball joint 350 to push the ball joint rod 360 so as to rotate the dispensing valve receptacle 290. The torsion springs 340 then return the dispensing valve receptacle 290 and the dispensing lever 260 to their original positions. Although operation of the dispensing valve receptacle 290 and the overall cradle and dispensing system 230 have been described in terms of the ball joint 350 and ball joint rod 360, any type of mechanical structure that provides rotational movement to the dispensing valve receptacle 290 may be used herein. Other examples include a push/pull lever in a linear orientation or any type of cams, gears, and combinations thereof.

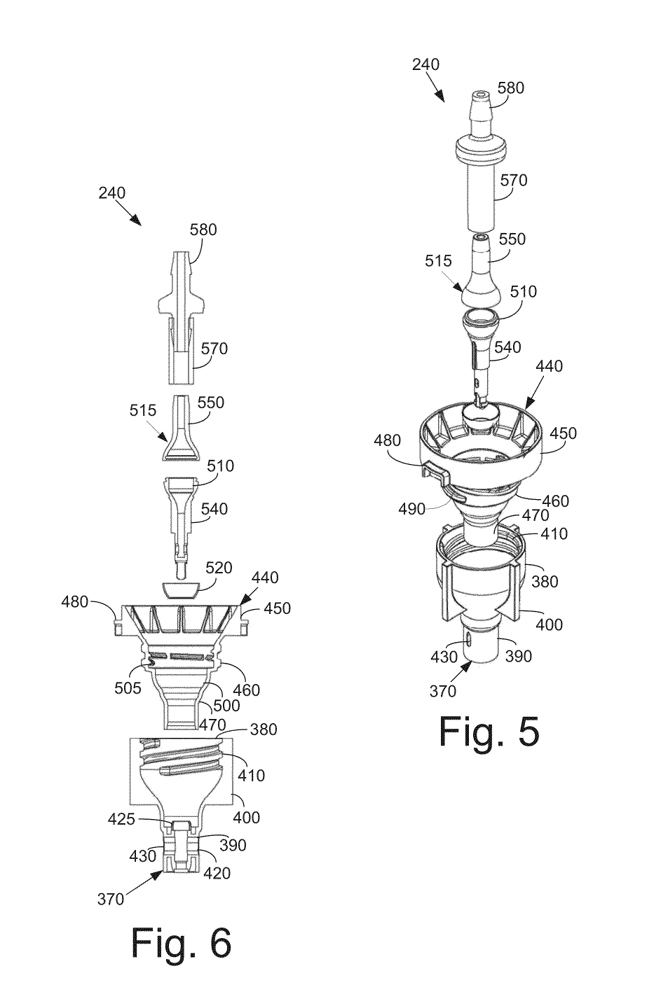

FIGS. 4-6 show an example of the dispensing valve 240. The dispensing valve 240 may be made out of any type of substantially rigid materials including molded thermoplastics and the like. The dispensing valve 240 may be sized according to the nature of the container 140 intended to be used therewith. As such, dispensing valves 240 of varying sizes may be used.

The dispensing valve 240 may include a nozzle 370. The nozzle 370 may have an upper nozzle body 380 and a lower nozzle spout 390. The upper body 380 may have a number of flanges 400 thereon. The flanges 400 may be sized to accommodate the keys 310 of the dispensing valve receptacle 290 for rotation therewith. The lower spout 390 may be sized to extend through the center aperture 300 of the dispensing valve receptacle 290. The nozzle 370 may be substantially hollow. The upper body 380 may have a number of internal threads 410 positioned therein. The lower spout 390 may include a number of airfoils 420 extending from a central bulb seat 425. The airfoils 420 may be in communication with an airflow path as will be described in more detail below. The airfoils 420 may be substantially hollow and may extend to an air inlet 430 positioned on the exterior of the spout 390. Other components and other configurations may be used herein.

A closure 440 may be positioned within the nozzle 370. The closure 440 may include a closure collar 450, a closure upper body 460, and a closure lower spout 470. The closure collar 450 may extend above the nozzle 370. The closure collar 450 may be sized to accommodate the collar 270 of the cradle 250. The closure collar 450 may include a number of closure flanges 480 or other types of structures that are sized to accommodate the guides 280 of the collar 270 of the cradle 250. The upper body 460 may include a number of outer closure threads 490. The outer closure threads 490 may be sized to accommodate the nozzle threads 410 of the nozzle 370 for rotation therewith. The lower closure spout 470 may be sized to accommodate the lower nozzle spout 390. The closure 440 may be substantially hollow with the lower spout 470 forming a sealing surface 500 therein. The lower spout 470 also may have internal closure threads 505 so as to accommodate the threads 165 of the container 140. Other components and other configurations may be used herein.

A bulb 510 may be positioned on a piston 515 within the closure 440. The bulb 510 may be any type of expanded structure that is sized to mate with the sealing surface 500 of the closure 440. A bulb seal 520 may surround the bulb 510. The bulb seal 520 may be a thermoplastic elastomer (TPE) seal or other types of compressible materials with good sealing characteristics in the context of the beverages 120 used herein. A fluid flow path 530 may extend between the bulb 510 and the sealing surface 500 of the spout 470 of the closure 440. The piston 515 may include a lower leg 540 and an upper leg 550 extending on either side of the bulb 510. The lower leg 540 and the upper leg 550 may be substantially hollow and may form an airflow path 560 therethrough. The lower leg 540 may be fixed within the bulb seat 425 and may be in communication with the airfoils 420. The upper leg 550 may be in communication with any length or any type of tubing 570. A check valve 580 and the like also may be used with the tubing 570. Other components and other configurations may be used herein.

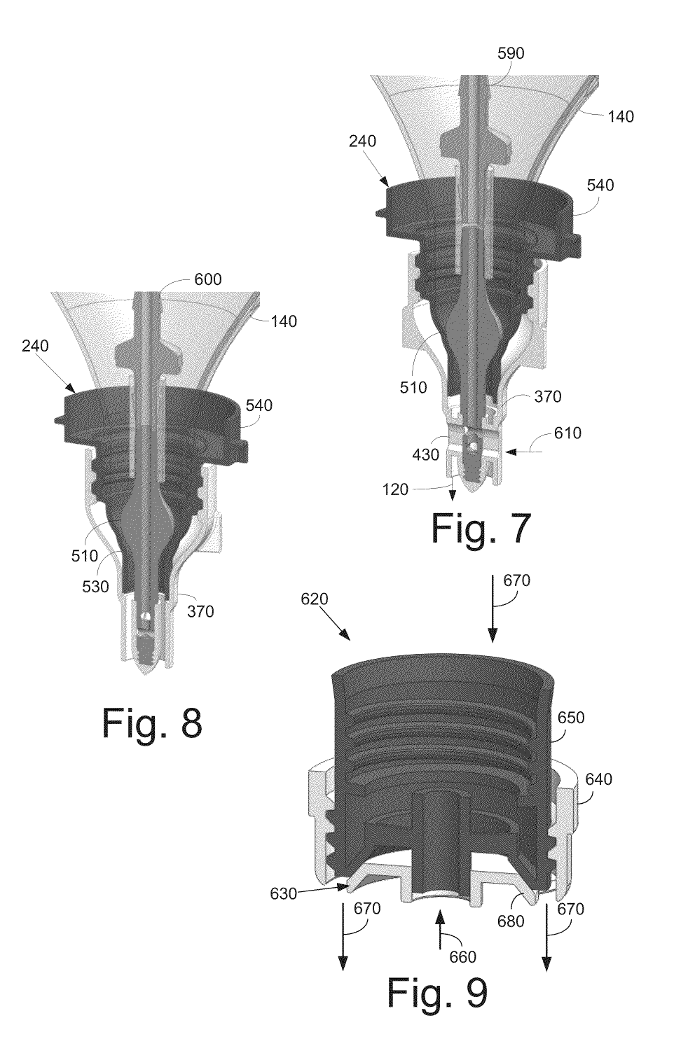

FIG. 7 and FIG. 8 show examples of the operation of the dispensing valve 240. The dispensing valve 240 may be positioned about the neck 160 of the container 140. Specifically, the inner closure threads 505 of the closure 410 mate with the neck threads 165 of the container 140. The dispensing valve 240 is shown in a closed position 590 in FIG. 7, i.e., the nozzle 370 is in a lowered position with respect to the closure 440. The container 140, with the dispensing valve 240 in the closed position 590, then may be positioned within the cradle 250. The nozzle 370 of the dispensing valve 240 extends through the center aperture 300 of the dispensing valve receptacle 290 with the flanges 400 of the nozzle 370 aligned with the keys 310. Likewise, the flanges 480 of the closure 440 may align with the guides 280 of the collar 270 of the cradle 250. The collar 270 may be rotated so as to lock the container 140 in place.

When a beverage 120 is desired to be dispensed, the dispensing lever 260 may be depressed such that the ball joint 350 and the ball joint rod 360 translate the downward vertical movement of the dispensing lever 260 into rotational movement. Specifically, the ball joint rod 360 forces the ball socket 315 of the dispensing valve receptacle 290 against the flanges 400 of the nozzle 370 such that the nozzle 370 rotates. The nozzle 370 may rotate about ninety degrees (90°) or so. Other degrees of rotation may be used herein. This rotation causes the nozzle 370 to move upwardly with respect to the closure 440 via the mating threads 410, 490.

Moving the nozzle 370 upward causes the bulb 510 to rise above the sealing surface 500 within the closure 440 so as to open the fluid flow path 530. The dispensing valve 240 is shown in an open or a raised position 600 in FIG. 8. The beverage 120 thus flows along the fluid flow path 530 through the dispensing valve 240. Likewise, a flow of air 610 flows through the air inlets 430 of the airfoils 420 and into the airflow path 560 through the piston 515 and into the container 140 so as to prevent the creation of a vacuum therein. Once the dispensing lever 260 is released, the torsion springs 340 return the dispensing lever 260 and the dispensing valve receptacle 290 to their original locations as is shown in the closed position 590. Other components and other configurations may be used herein.

FIGS. 9-11 show several variations on the dispensing valve 240. FIG. 9 shows a dispensing valve 620 with concentric flow paths 630. The dispensing valve 620 may include a nozzle 640 for rotation about a closure 650. The closure 650 may include a central air path 660 surrounded by a fluid flow path 670. The fluid flow path 670 may be closed by a sealing surface 680 positioned on the nozzle 640. Other components and other configurations may be used herein.

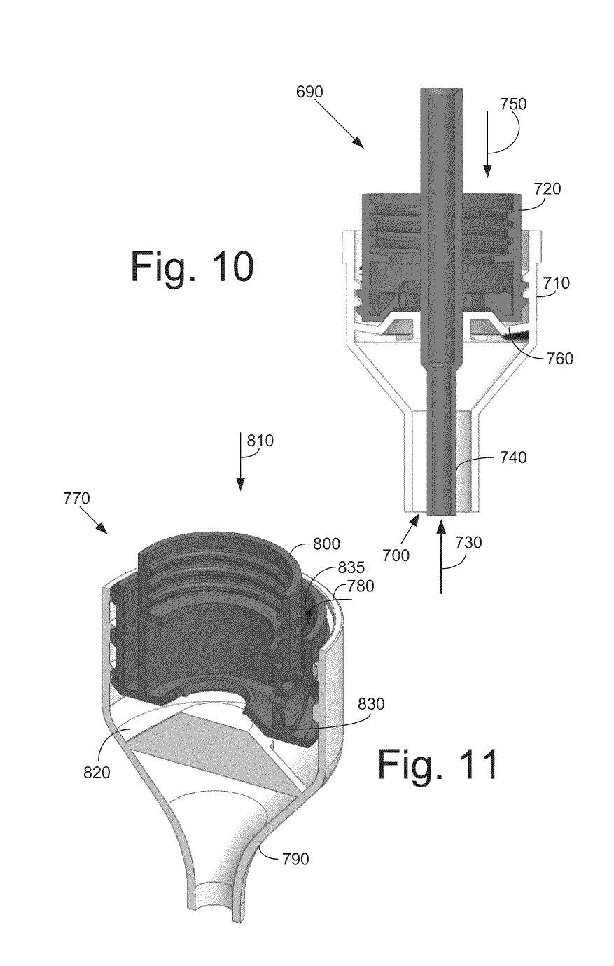

FIG. 10 shows a further example of a dispensing valve 690 with a concentric flow path 700. The dispensing valve 690 may include a nozzle 710 for rotation about a closure 720. In this example, the closure 720 includes an air path 730 in the form of an elongated tube 740. A fluid flow path 750 surrounds the air tube 740. The fluid flow path 750 may be sealed by a sealing surface 760 positioned on the nozzle 710. Other components and other configurations may be used herein.

FIG. 11 shows a further example of a dispensing valve 770. The dispensing valve 770 may have a side airflow configuration 780. The dispensing valve 770 may include a nozzle 790 and a closure 800 for rotation therewith. The closure 800 may have a central fluid flow path 810 extending therethrough. The fluid flow path 810 may be sealed by a sealing surface 820 positioned on the nozzle 790. The closure 800 may include a side air inlet 830 positioned thereon for a flow of air therein via an air channel 835 extending between the nozzle 790 and the closure 800. Other components and other configurations may be used herein.

The respective airflow paths described herein may pass through the check valve 580. The check valve 580 may be any type of valve or other structure to prevent the passage of fluid therein. These valves may include diaphragm valves, umbrella valves, duckbill valves, and the like. Other components and other configurations also may be used herein.

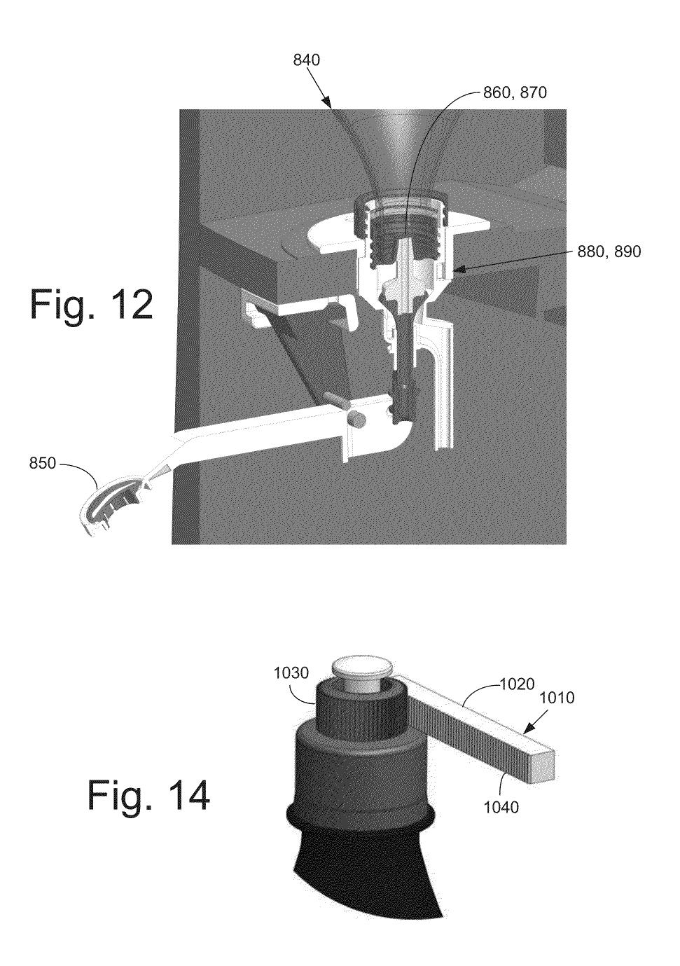

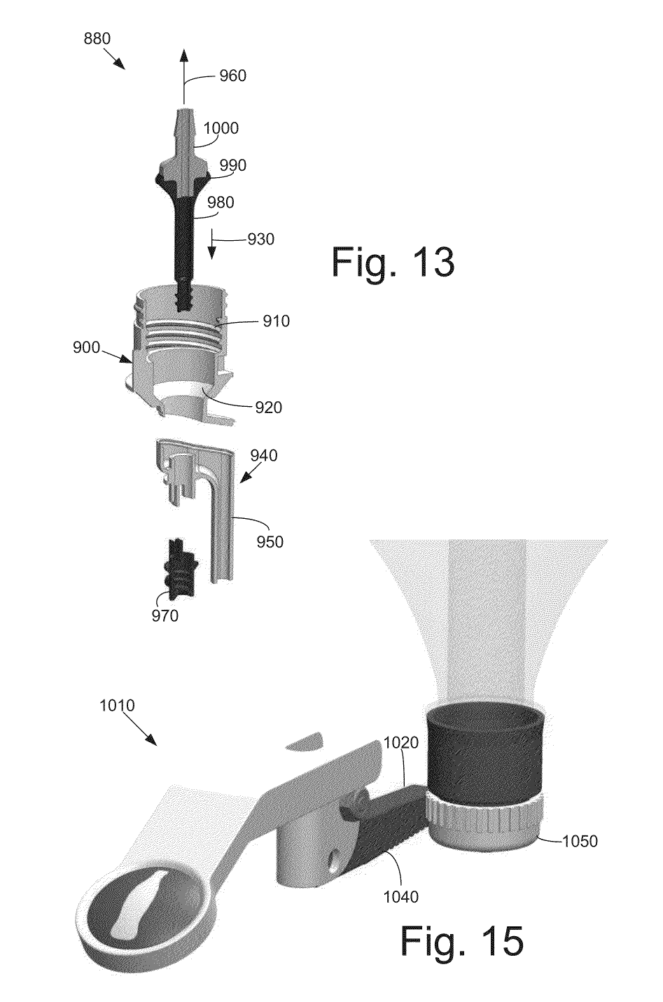

FIG. 12 and FIG. 13 show an alternative embodiment of a cradle and dispensing system 840 as may be described herein that may be used with the dispensing system 100. In this example, the cradle and dispensing system 840 may largely use the cradle 250 as described above. Likewise, the cradle and dispensing system 840 may have a simplified dispensing lever 850. In this example, the dispensing lever 850 simply provides largely vertical motion. The cradle and dispensing system 840 may be intended to be used with a container 140 with a breakaway closure 860 positioned thereon. The breakaway closure 860 may include a frangible valve 870 and the like. Alternatively, the breakaway closure 860 may include a surface that may accommodate piercing or other types of openings.

The cradle and dispensing system 840 also includes a dispensing valve 880 for use therewith. The dispensing valve 880 may include concentric flow paths 890 therethrough. The dispensing valve 880 may include a nozzle 900. The nozzle 900 may have internal threads 910 so as to mate with the threads 165 of the container 140. The nozzle 900 may be substantially hollow with a sealing surface 920 and a fluid flow path 930 therethrough. A nozzle tube base 940 may be positioned beneath the nozzle 900. The nozzle tube base 940 may include an offset tube 950 for the fluid flow path 930 to extend therethrough. A central airflow path 960 may extend through the nozzle tube base 940. A lever stem 970 may be positioned beneath the nozzle tube base 940. The lever stem 970 may be attached to dispensing lever 850 for movement therewith. The airflow path 960 may extend through the lever stem 970 in whole or in-part. Other components and other configurations may be used herein.

An internal piston 980 may be attached to the lever stem 970 and may extend through the nozzle tube 940 and the nozzle 900. The piston 980 may be substantially hollow with the airflow path 960 extending therethrough. The piston 980 may expand into a bulb 990. The bulb 990 may be sized to accommodate the sealing surface 920. A check valve 1000 may extend beyond the bulb 990 with the airflow path 960 extending therein.

In use, the container 140 with the breakaway closure 860 thereon may be positioned within the dispensing valve 880 and the cradle 950 of the cradle and dispensing system 840 and secured therein. Upon depressing the dispensing lever 850, the piston 980 of the dispensing valve 880 may be forced upward such that the check valve 1000 breaks the frangible valve 870 on the breakaway closure 860. Likewise, the bulb 990 on the piston 980 may be raised away from the sealing surface 920. The beverage 120 thus flows through the fluid flow path 930 and out via the nozzle tube base 940. Meanwhile, the flow of air 610 extends along the airflow path 960 through the lever stem 970, the nozzle tube 940, the piston 980, and the check valve 1000. Use of the offset tube 950 thus provides separation of the fluid flow path 930 and the airflow path. When the dispensing lever 850 is raised to its original position, the bulb 990 of the piston 980 may again seal against the sealing surface 920. Other components and other configurations also may be used herein. Likewise, any structure that delivers substantially vertical motion may be used herein.

FIGS. 14 and 15 show alternative examples of the dispensing lever 260. FIG. 14 shows the use of a rack and pinion system 1010. The rack and pinion system 1010 may be used with a closure 1020 with compatible gear teeth 1030. Depressing the dispensing lever 1040 with the rack and pinion system 1010 thus causes linear motion such that the gear teeth 1030 force the closure 1020 to rotate. Other types of horizontal or linear movement devices also may be used herein. Similarly, FIG. 15 shows the dispensing lever 1010 with the rack and pinion system 1010 used to open a valve 1050 instead of the closure 1020 itself. Other components and other configurations may be used herein.

The dispensing system 100 described herein thus provides efficient dispensing of beverages 120 without the use of electro-mechanical parts or even the use of electricity. The dispensing system 100 allows the use of conventional containers 140 with a ready to drink beverage 120 therein instead of relying on the multiple ingredients usually required in conventional dispensers. The dispensing system 100 thus may be used in almost any location without regard to local conditions. The dispensing system 100 also may be portable.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A dispensing system for dispensing a beverage from a container, comprising:
a dispensing valve adapted to be positioned within the container;
a dispensing valve receptacle for receiving the dispensing valve; and
a dispensing lever connected to the dispensing valve receptacle;
wherein moving the dispensing lever causes the dispensing valve receptacle to rotate the dispensing valve so as to dispense the beverage from the container.

2. The dispensing system of claim 1, further comprising a collar positioned about the dispensing valve receptacle for positioning the container therein.

3. The dispensing system of claim 1, wherein the dispensing valve receptacle comprises a central aperture to receive the dispensing nozzle and one or more keys positioned thereabout.

4. The dispensing system of claim 1, wherein the dispensing lever comprises one or more springs thereon.

5. The dispensing system of claim 1, wherein the dispensing lever comprises a ball joint in connection with the dispensing valve receptacle.

6. The dispensing system of claim 1, wherein the dispensing valve comprises a nozzle rotatable about a closure.

7. The dispensing system of claim 6, wherein the nozzle comprises one or more flanges to engage the dispensing valve receptacle.

8. The dispensing system of claim 6, wherein the nozzle comprises one or more inner threads and the closure comprises one or more mating outer threads.

9. The dispensing system of claim 6, wherein the nozzle comprises one or more airfoils with an airflow path therethrough.

10. The dispensing system of claim 6, wherein the closure comprises a sealing surface therein.

11. The dispensing system of claim 6, wherein the closure comprises one or more inner threads to accommodate the container.

12. The dispensing system of claim 6, wherein the dispensing nozzle comprises a piston positioned within the nozzle and the closure.

13. The dispensing system of claim 12, wherein the piston comprises a bulb thereon for sealing a fluid flow path through the closure.

14. The dispensing system of claim 12, wherein the piston comprises an air flow path therethrough.

15. The dispensing system of claim 12, wherein the dispensing valve comprises a check valve positioned on the piston.

16. The dispensing system of claim 6, wherein the nozzle and the closure comprise a plurality of concentric flow paths therethrough.

17. The dispensing system of claim 6, wherein the nozzle and the closure comprise an elongated tube therethrough.

18. The dispensing system of claim 6, wherein the closure comprises a side air inlet.

19. The dispensing system of claim 1, wherein the dispensing nozzle comprises a closed lower position and an open upper position.

20. The dispensing system of claim 1, wherein the container comprises breakaway closure.

21. A method of dispensing a beverage from a container, comprising:
positioning a dispensing valve within the container;
positioning the dispensing valve and the container within a collar;
rotating a nozzle portion of the dispensing valve so as to raise a bulb away from a sealing surface to create a fluid flow path therethrough; and
providing an air flow path through one or more airfoils positioned within the nozzle.

22. A dispensing system for dispensing a beverage from a container, comprising:
a closure adapted to be positioned on the container;
the closure comprising a frangible seal;
a cradle for receiving the container;
a dispensing valve positioned adjacent to the container; and
a dispensing lever connected to the dispensing valve;
wherein moving the dispensing lever causes the dispensing valve to break the frangible seal so as to dispense the beverage from the container.

23. The dispensing system of claim 22, wherein dispensing valve comprises a plurality of concentric flow paths therethrough.

24. The dispensing system of claim 22, wherein the dispensing valve comprises a nozzle with a sealing surface therein.

25. The dispensing system of claim 24, wherein the dispensing valve comprises a piston within the nozzle.

26. The dispensing system of claim 25, wherein the piston comprises an air flow path therethrough.

27. The dispensing system of claim 25, wherein the piston comprises a bulb thereon.

28. The dispensing system of claim 25, wherein the dispensing nozzle comprises a lever stem attached to the piston.

29. The dispensing system of claim 24, wherein the dispensing nozzle comprises a nozzle tube adjacent to the nozzle.

30. The dispensing system of claim 29, wherein the nozzle tube comprises an offset tube with a fluid flow path therethrough.

31. A dispensing valve for dispensing a beverage from a container, comprising:
a closure sized for the container;
a nozzle rotatably positioned about the closure; and
a piston attached to the nozzle and extending through the closure;
wherein rotation of the nozzle causes the piston to disengage from a sealing surface in the closure.

32. The dispensing valve of claim 31, wherein the nozzle comprises one or more inner threads and the closure comprises one or more mating outer threads.

33. The dispensing valve of claim 31, wherein the nozzle comprises one or more airfoils with an airflow path therethrough.

34. The dispensing valve of claim 31, wherein the closure comprises one or more inner threads to accommodate the container.

35. The dispensing valve of claim 31, wherein the piston comprises a bulb thereon for sealing a fluid flow path through the closure.

36. The dispensing valve of claim 31, wherein the piston comprises an air flow path therethrough.

37. The dispensing valve of claim 31, wherein the dispensing valve comprises a check valve positioned on the piston.
